(19) United States
(12) Patent Application Publication
(10) Pub. No.: US 2012/0040124 A1
(43) Pub. Date: Feb. 16, 2012

(54) REINFORCED WALKWAY SYSTEM

(75) Inventor: James P. Ellis, Waltham, MA (US)

(73) Assignee: THE BILTRITE CORPORATION, Waltham, MA (US)

(21) Appl. No.: 13/204,783

(22) Filed: Aug. 8, 2011

Related U.S. Application Data
(60) Provisional application No. 61/372,309, filed on Aug. 10, 2010.

(51) Int. Cl. E04B 5/00; B32B 27/08; B32B 3/30; B32B 38/06; B32B 27/00

(52) U.S. Cl. 428/41.8; 156/219; 428/212; 428/169; 428/688

(57) ABSTRACT

Disclosed is a reinforced walkway system having an embossed walkway performance layer made of a polymer composite and a composite reinforcement layer thermally bonded thereto. The reinforcement layer includes a high temperature reinforcing composite which is thermally applied to the underside of the performance layer to prevent delamination and maintain the dimensional stability of the embossed performance layer at high temperatures. In one embodiment, the walkway performance layer may comprise any of polyolefin (TPO), Polyvinylchloride (PVC), and Elvaloy/Polyvinylchloride optionally mixed with other additives such as UV protection or mineral fillers. A method of forming a reinforced walkway system includes substantially simultaneously thermally bonding the performance layer to the composite reinforcement layer and embossing the performance layer.

### FIELD OF THE INVENTION

The disclosure relates to walkway systems, and, more particularly, to a reinforced walkway system with thermal protection, superior dimensional stability and high reflectivity and high emissivity properties.

### BACKGROUND

There currently exists commercially available roof walkway systems that are designed to protect single-ply roof membrane from foot traffic damage, thermal degradation, dragged or wheeled objects and usage or damage from dropped tools. One such system is the Tuff Trac® Roof Walkway System available from The Biltrite Corporation, Waltham, Mass. 02453. Because such systems are secured to the roof of the structure, they are exposed to the elements, particularly extreme temperatures, for extended periods, depending on the geographic location of the structure. Particularly in more southerly and westerly areas, extreme heat and exposure to ultraviolet rays can cause dimensional instability, and UV damage to the material from which the system is constructed. In areas of frequent precipitation, traction and water channeling concerns arise.

Accordingly, need exists for a roof walkway system which possesses improved thermal protection, dimensional stability, high reflectivity and high emissivity properties, and channels water efficiently.

### SUMMARY

Disclosed is a reinforced walkway system comprising an embossed walkway performance layer having a composite reinforcement layer thermally bonded thereto. The performance layer may be manufactured from fibrous recycled thermoplastic or rubber scrap that creates dimensional stability within the polymer formulation thereof and may have a pattern embossed thereon, such as a herringbone pattern, that allows for superior water drainage. The reinforcement layer may comprise a high temperature reinforcing composite which is thermally applied to the underside of the performance layer to prevent delamination therefrom during the product life and which provides a medium that maintains the dimensional stability of the embossed performance layer at high temperatures.

According to one aspect of the disclosure, an article of manufacture comprises a walkway performance layer comprising a polymer composite and a reinforcement layer secured thereto, the reinforcement layer being a composite layer formed of a plurality of materials. In one embodiment, the walkway performance layer may comprise any of polyolefin (TPO), Polyvinylchloride (PVC), and Elvaloy/Polyvinylchloride optionally mixed with other additives such as UV protection or mineral fillers. In another embodiment, the reinforcement layer may comprise a plurality of different materials chosen to maintain the dimensional stability of the embossed walkway at high temperatures.

According to another aspect of the disclosure, a method of forming a reinforced walkway system comprises: a) providing a walkway performance layer comprising a polymer composite; b) providing a composite reinforcement layer formed of a plurality of materials; c) thermally fusing the performance layer and the reinforcement layer together to form a fused layer therebetween, while substantially simultaneously embossing the performance layer.

### DESCRIPTION THE DRAWINGS

FIG. 1 is a perspective view of the walkway system 5 illustrating an embossment formed into the performance layer thereof;

FIGS. 2A-G illustrates conceptually perspective cut-away views of the multiple layers of the walkway system 5A-G in accordance with various embodiments disclosed herein; and

FIG. 3 is a conceptual illustration of a thermal forming process used to create the walkway systems disclosed herein.

### DETAILED DESCRIPTION

A reinforced walkway system 5 in accordance with the disclosure comprises an embossed walkway layer 10 and a composite reinforcement layer 30. A thermal fusion layer 20 is formed at the juncture of layers 10 and 30 during the manufacturing process. In another embodiment, layer 30 has a polymer adhesive layer 40 and release layer 50 formed there under to facilitate peel and stick attachment of system 5 to a roof structure. The system 5 is designed to protect single-ply roof membrane from foot traffic damage, thermal degradation, dragged or wheeled objects and usage or damage from dropped tools. System 5 offers superior dimensional stability versus non-reinforced walkway forms.

### Performance Layer

In one embodiment, layer 10 may comprise a mineral filled, recycled thermoplastic such as one or more of polyolefin (TPO), Polyvinylchloride (PVC), or Elvaloy/Polyvinylchloride blend. Layer 10 may comprise both post industrial and post consumed thermoplastic or rubber materials. Specifically, layer 10 may be manufactured from fibrous recycled thermoplastic or rubber scrap that creates dimensional stability within the polymer formulation by adding structural integrity. Layer 10 maybe manufactured from recycled roofing membrane resin which is mixed via a direct compounding process by itself or with prime resins and other additives such as UV protection or mineral fillers to promote the proper longevity of the product in outdoor weathering conditions. In one embodiment, layer 10 may be implemented with a commercially available material, such as the Tuff Trac® Roof Walkway System available from The Biltrite Corporation, Waltham, Mass. 02453.

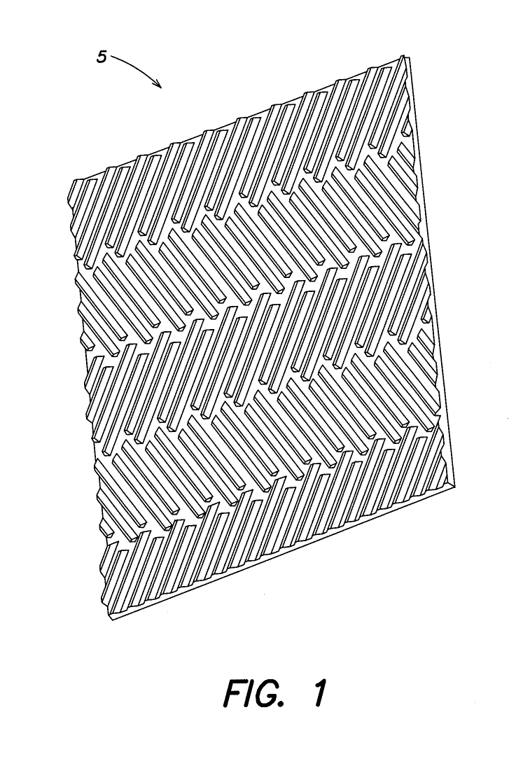

Layer 10 may be designed with a herringbone embossment on the upward or exterior surface thereof, as illustrated in FIG. 1, that allows for superior water drainage. Although some embossment surfaces used in the trade have interconnected sections, the channel design of the herringbone embossment allows for the more effective water drainage of the surface area of the walkway. Typically, water ponding occurs in low lying areas of low slope single-ply roofing structures so water drainage is important to maintaining a sure foot surface for roof top traffic.

In an alternative embodiment, other embossing patterns may be formed into performance layer 10, including Diamond Plate embossment, Pyramid embossment, or similar patterns which provide both improved traction and water channeling characteristics.

### Composite Reinforcement Layer

Layer 30, in one embodiment, comprises a high temperature reinforcing composite which is thermally applied to the backside of the walkway performance layer 10 to prevent delamination of the performance layer during the product life. The composite reinforcing layer 20, which in one embodiment may be fabric reinforced, provides a backing medium that maintains the dimensional stability of the embossed walkway at high temperatures (defined as greater than 158 Fahrenheit up to 250 Fahrenheit).

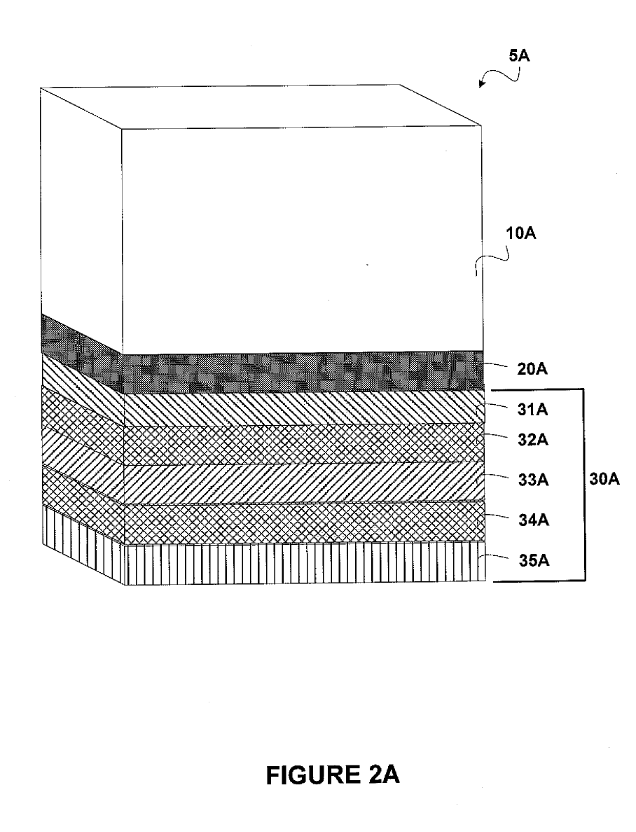

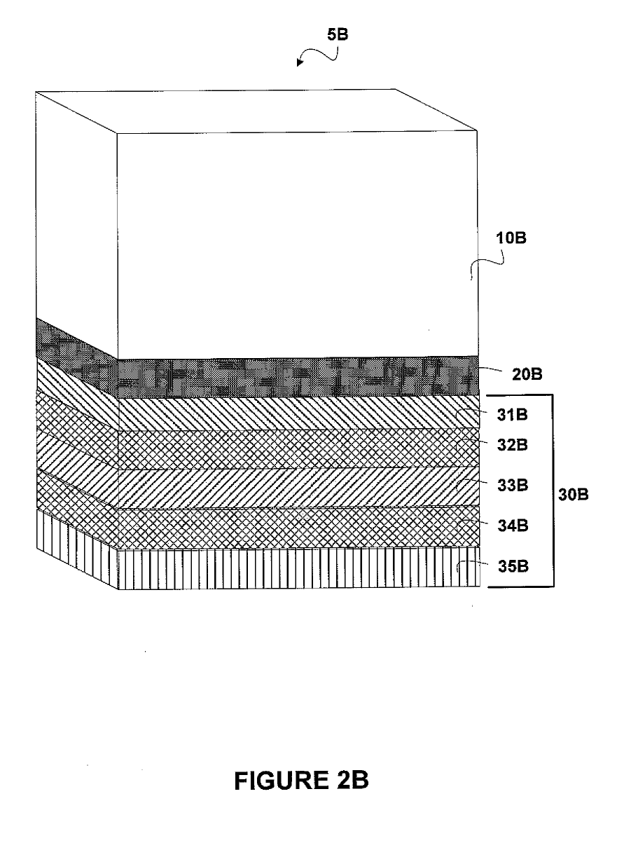

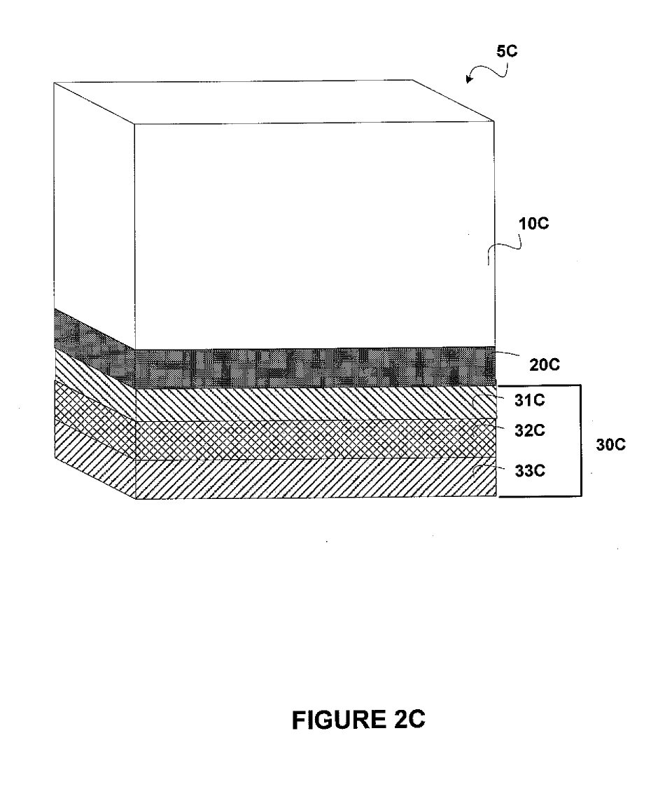

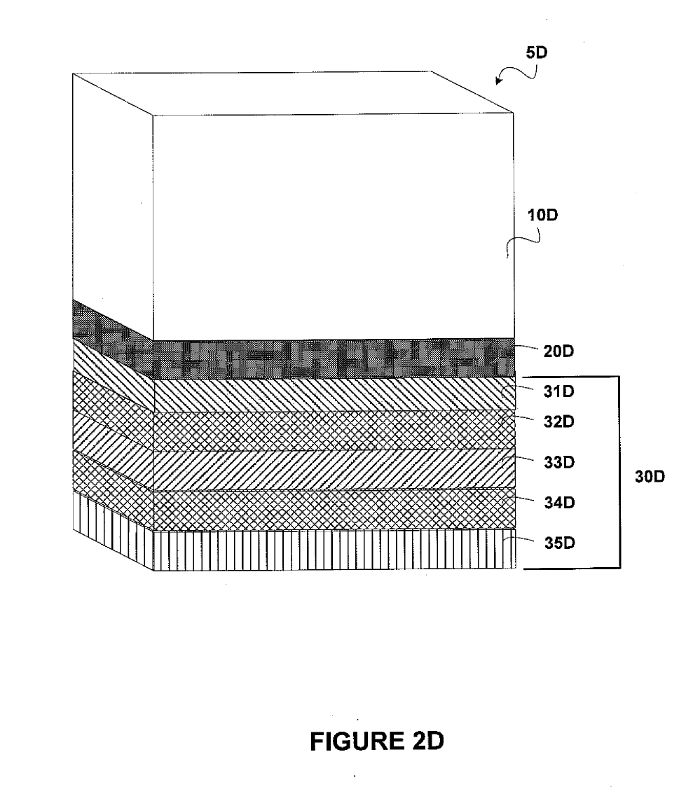

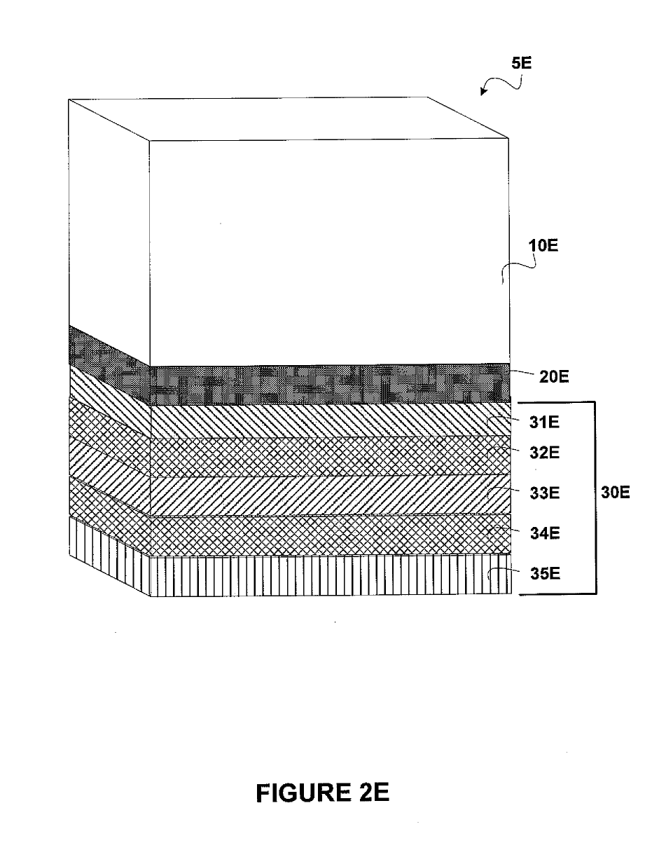

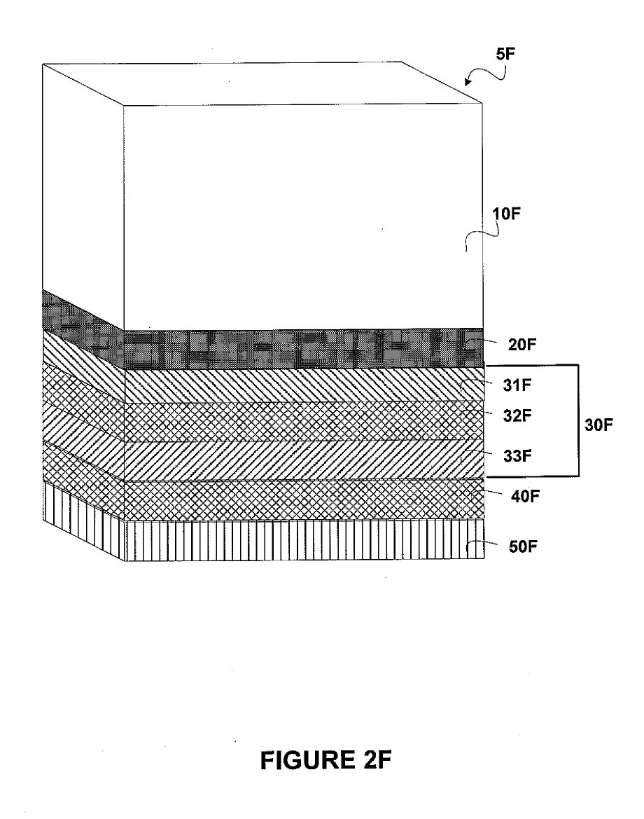

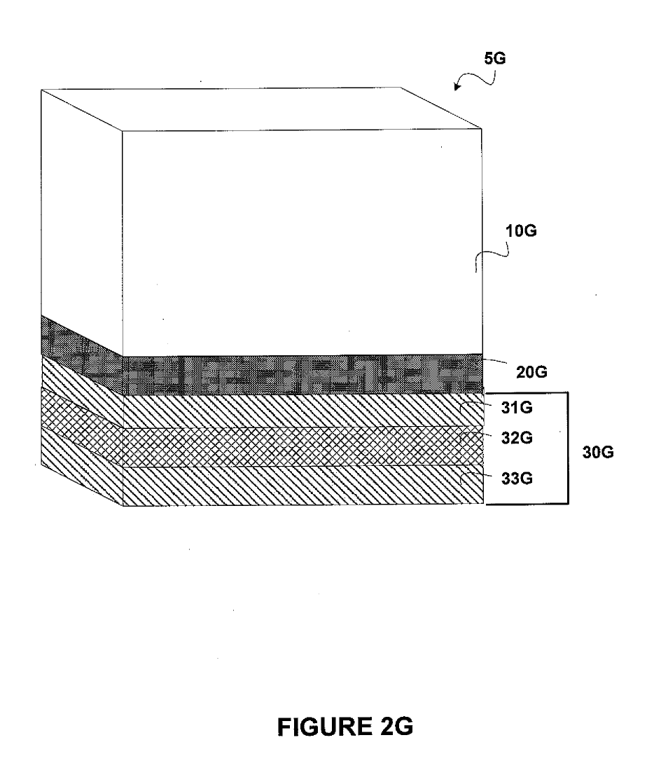

FIGS. 2A-G illustrates conceptually perspective, cut-away views of the multiple layers of the walkway system in accordance with various embodiments disclosed herein, the layers in such figures not being shown to their true dimensions. In FIGS. 2A-G, the herringbone or other embossment pattern in layer 10 is not illustrated for simplicity purposes.

Referring to FIG. 2A, a walkway system 5A is illustrated as comprising a performance walkway layer 10A, a thermal fusion layer 20A and a composite reinforcement layer 30A. Layer 10A may have the composition described herein. Layer 20A represents the thermal fusion juncture of embossed walkway layer 10A with composite reinforcement 30A as formed using manufacturing processes described herein. In system 5A, composite reinforcement layer 30A comprises a polyolefin film 31A, an acrylic adhesive layer 32A, a fiberglass fabric 33A, an acrylic adhesive 34A, and a Mylar polyester film 35A formed into a single composite layer.

Referring to FIG. 2B, a walkway system 5B is illustrated. Walkway system 5B is similar in construction, composition and function to system 5A of FIG. 2A, except that Mylar polyester film 35A layer is replaced with a reflective foil layer 35B of layer 30B, as illustrated.

Referring to FIG. 2C, a walkway system 5C is illustrated. Walkway system 5C is similar in construction, composition and function to system 5A of FIG. 2A, except that composite layer 30A has been replaced with composite layer 30C which comprises a Polyolefin film 31C, a Fiberglass or Polyester fabric 32C, and Polyethylene film 33C, as illustrated.

Referring to FIG. 2D, a walkway system 5D is illustrated. Walkway system 5D is similar in construction, composition and function to system 5A of FIG. 2A, except that the polyolefin film 31A of composite layer 30A has been replaced with a polyvinylchloride film 31D of composite layer 30D, as illustrated.

Referring to FIG. 2E, a walkway system 5E is illustrated. Walkway system 5E similar in construction, composition and function to system 5B of FIG. 2B, except that the polyolefin film 31B of composite layer 30B has been replaced with a polyvinylchloride film 31E of composite layer 30E, as illustrated.

Referring to FIG. 2F, a walkway system 5F is illustrated as comprising a performance walkway layer 10F, a thermal fusion layer 20F and a composite reinforcement layer 30F. Layer 10F may have the composition similar to other layers 10 as, described herein.

Layer 20F represents the thermal fusion juncture of embossed walkway layer 10F with composite reinforcement 30F as formed using manufacturing processes described herein. In system 5F, composite reinforcement layer 30F comprises either a polyolefin or polyvinyl chloride film 31F, a fiberglass or polyester fabric 32F, and a Mylar polyester film or reflective foil 35F, as illustrated. In addition system 5F comprises a layer 40F of extruded or coated modified butyl rubber or thermoplastic polymer adhesive disposed on the under surface of layer 30F. Adjacent layer 40F is a removable layer 50F comprising a silicon coated release liner. The system 5F as illustrated in FIG. 2F facilitates rapid and easy you stick application of the system to the roof surface.

Referring to FIG. 2G, a walkway system 5G is illustrated. A walkway system 5G is illustrated as comprising a performance walkway layer 10G, a thermal fusion layer 20G and a composite reinforcement layer 30G. Layer 10G may be formed from a composition comprising approximately 40%-75% fibrous recycled roof membrane. Layer 20G represents the thermal fusion juncture of embossed walkway layer 10G with composite reinforcement 30G as formed using manufacturing processes described herein. In system 5G, composite reinforcement layer 30G comprises a polypropylene film 31G, a polyester fabric 32G, and another layer of polypropylene film 33G formed into a single composite layer.

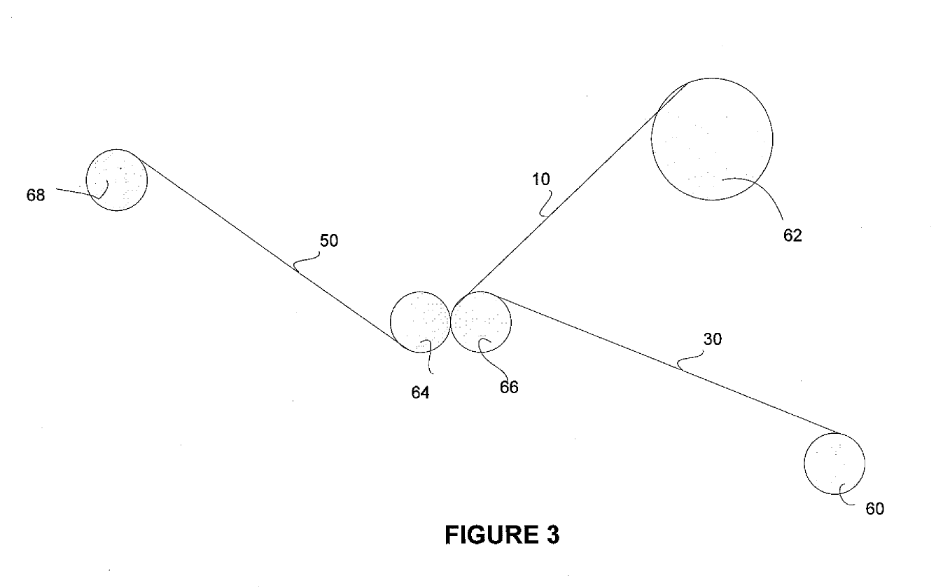

The various system embodiments illustrated in FIGS. 1-2G may be manufactured using a thermal forming process illustrated by the conceptually in FIG. 3. Specifically, the reinforcement layer 30, as described herein, and the walkway performance layer 10, also as described herein, are simultaneously supplied from a film roller 60 and extruded roller 62, respectively, to a pair of embossing rollers 64 and 66 where the layers 10 and 20 are thermally fused to form layer 20 and embossed substantially simultaneously, resulting in a finished laminated walkway system 5 which is spooled to idle roller 68. Note in this process that composite layer 30 and performance layer 10 have been previously formed prior to spooling onto rollers 60 and 62, respectively, for formation of layer 20 and system 5. In the case of system 5F, layers and 30F, 40F and 50F have been previously formed together and spooled prior to their joining with layer 10F. In some embodiments, the width of the finished laminated walkway system may be about 60 inches.

### System Benefits

System 5 as disclosed herein provides a sure foot pathway that is slip resistant due to the deep herringbone embossment that will not wrinkle or exhibit distortion at high temperature extremes.

System 5 maybe applied to existing roof membrane surfaces with direct thermal bonding. In one embodiment, a reinforced walkway comprising system 5 is designed with a welding edge that is not reinforced to allow for undisturbed thermal bonding of walkway to the roof membrane. The non-reinforced edge is supported from dimensional movement by the underlying roof membrane.

System 5 may be manufactured with a brightly colored safety edge applied to the outside edges of the walkway surface for easy identification of the high raised area of the protective walkway.

As noted previously, system 5 maybe made with a high temperature reinforcing composite to provide a high reflective and emissive layer for thermal protection of the underlying roof membrane.

It will be obvious to those recently skilled in the art that modifications to the article of manufacture and process disclosed here in may occur, including substitution of various materials within the compounds of layers and different layer configurations, without parting from the true spirit and scope of the disclosure.

What is claimed is:

1. An article of manufacture, comprising:
a walkway performance layer; and
a reinforcement layer secured to the walkway performance layer, the reinforcement layer having greater dimensional stability than the walkway performance layer at high temperature.

2. The article of claim 1, wherein the reinforcement layer comprising materials selected from:
polyolefin (TPO),
polyvinylchloride (PVC),
polypropylene, and
elvaloy/polyvinylchloride.

3. The article of claim 2, wherein the elvaloy/polyvinylchloride being mixed with at least one of UV protection and mineral fillers.

4. The article of claim 1, wherein a thermal fusion layer adhesively attaches the reinforcement layer to the walkway performance layer.

5. The article of claim 1, wherein the walkway performance layer comprises a surface having a herringbone embossment.

6. The article of claim 1, wherein the reinforcement layer at least partially comprises a material that provides dimensional stability to the walkway performance layer when secured.

7. The article of claim 1, wherein the reinforcement layer comprises in combination, any of polyolefin film, fiberglass fabric, and polyester film.

8. The article of claim 1, wherein the reinforcement layer comprises in combination, any of polyolefin film, fiberglass fabric, and reflective foil.

9. The article of claim 1, wherein the reinforcement layer comprises in combination, any of polyolefin film, fiberglass fabric, and polyethylene film.

10. The article of claim 1, wherein the reinforcement layer comprises in combination, any of polyvinylchloride film, at least one of fiberglass and polyester fabric, and polyester film.

11. The article of claim 1, wherein the reinforcement layer comprises in combination, any of polyvinylchloride film, at least one of fiberglass and polyester fabric, and reflective foil.

12. The article of claim 1, wherein the reinforcement layer comprises in combination, any of at least one of polyolefin and polyvinylchloride film, fiberglass and polyester fabric, and at least one of polyester film or reflective foil.

13. The article of claim 11, further comprising:
a silicone coated release liner; and
wherein at least one of a modified butyl rubber and a thermoplastic polymer adhesive adhesively attaches the reinforcement layer to the layer of the silicone coated release liner.

14. A method of forming a reinforced walkway system, comprising:
a) providing a walkway performance layer comprising a polymer composite;
b) providing a composite reinforcement layer formed of a plurality of materials;
c) securing the performance layer to the reinforcement layer while substantially simultaneously embossing the performance layer.

15. The method of claim 13, wherein c) comprises thermally fusing the performance layer and the reinforcement layer together.

16. The method of claim 13, further comprising forming the composite reinforcement layer from a plurality of mineral filled, recycled thermoplastics.

17. The method of claim 13, further comprising forming a composite reinforcement layer from a plurality of materials selected from a group comprising of:
polyolefin (TPO),
polyvinylchloride (PVC),
polypropylene, or
elvaloy/polyvinylchloride optionally mixed with other additives such as UV protection or mineral fillers.

18. The method of claim 13, further comprising:
adhesively attaching the reinforcement layer to a layer of a silicone coated release liner.

19. A walkway system, comprising:
a walkway performance layer comprising a polymer composite; and
a reinforcement layer secured to the walkway performance layer, the reinforcement layer being a mineral filled, recycled thermoplastic.

20. The system of claim 19, wherein a thermal fusion layer adhesively attaches the reinforcement layer to the walkway performance layer.
